(19) United States
(12) Patent Application Publication
(10) Pub. No.: US 2010/0159903 A1
(43) Pub. Date: Jun. 24, 2010

(54) PERSONALIZED MOBILE DATA ENHANCEMENT

(75) Inventor: Claudia V. Goldman-Shenhar, Mevasseret Zion (IL)

Correspondence Address: KEVIN D. MCCARTHY;ROACH BROWN MCCARTHY & GRUBER, P.C., 424 MAIN STREET, 1920 LIBERTY BUILDING, BUFFALO, NY, 14202, US

(73) Assignee: SAMSUNG ELECTRONICS CO., LTD., Gyeonggi-do (KR)

(21) Appl. No.: 12/342,473

(22) Filed: Dec. 23, 2008

(51) Int. Cl. H04M 3/42; H04M 3/00

(52) U.S. Cl. 455/414.2; 455/418

(57) ABSTRACT

A method for the personalized enhancement of a mobile device data comprises acquiring from the World Wide Web, through a mobile device, information relevant to said mobile device's data and displaying said updated information at the time and in a manner compatible with the user's pattern of use of the mobile device and to the user's relevant personal preference.

### FIELD OF THE INVENTION

The present invention relates to the procuring and use of data for mobile users.

### BACKGROUND OF THE INVENTION

In today's world, and particularly for business users, mobile devices have become an essential and central element of the “mobile office”. Because users increasingly find themselves on the move, there is a need to maintain the personal existing data on a mobile device constantly updated. While much information is available on the web, the problem with which mobile users are confronted is how to maximize the value and use of the personal data in a mobile device by updating it constantly with relevant information from the Web. This problem presents several aspects: acquisition, notification and organization of personalized information on a mobile device relevant to the user's contacts, calendar items, files, tasks and wish lists.

The art had so far failed to provide a useful solution that will answer, inter alia, the following questions:

1. What information to look for?

2. Where to look for it?

3. When to look for it?

4. When to notify the user of new information made available?

5. How to present the information to the user?

It is an object of the present invention to provide a method and system that answers the above identified questions and addresses those and other needs of mobile users, in an efficient and useful way.

### SUMMARY OF THE INVENTION

A method for the personalized enhancement of a mobile device data comprises acquiring from the World Wide Web, through a mobile device, information relevant to said mobile device's data and displaying said updated information at the time and in a manner compatible with the user's pattern of use of the mobile device and to the user's relevant personal preference. The information can be selected, for instance, from information relevant to the user's contacts, calendar items, files, sms messages, and WishLists.

According to one embodiment of the invention, but not limitatively, data is acquired during periods of time when said acquisition does not interfere with the user's usage of the mobile device. The type of information and/or the times of update are selected, in one embodiment of the invention, based on probabilities of need and/or usage by the user, based on the user's previous patterns of use.

The invention is useful in relation to mobile devices in general and, specifically it is widely useful when the mobile device is a cellular phone.

Each step in the method of the invention can be controlled either deterministically or directly by the user, or by a combination of direct and deterministic processes. Of course, each step can suitably be controlled by the application of a software agent.

The quality and/or the length of the content presented to the user should be controlled, to avoid overflow of information that may limit its usefulness. The quality and length can be predetermined by the user or can be factory preset. They can further be determined according to variables of the mobile device, such as remaining battery life and scheduled user activities.

### BRIEF DESCRIPTION OF THE DRAWINGS

In the drawings:

FIG. 1 is a schematic illustration of the invention;

FIG. 2 is an example of operation according to the invention; and

FIG. 3 shows a cost-benefit computation algorithm that can be used in conjunction with the invention.

### DETAILED DESCRIPTION OF THE INVENTION

Many methods are provided in the art for computer users, to update the user with information added to the web, which methods are unsuitable and not useful for users of mobile devices to which the present invention is directed. Illustrative examples of such prior art methods include Google alerts (http://www.google.com/alerts), which collects material relevant to some expression of keywords from the sources of Google and send them by email to the interested user at the periods of time predetermined by the user chosen from a given menu. In this case, the decision about what to search for it given explicitly by the user. This type of process in unsuitable for the purposes described above, because, inter alia, it does not find when and how it is beneficial to look for the information and when and how it is beneficial to present it to the user. Also, the decision as to what information to look for, according to the invention and as will be further elaborated below, is different from the user's submitted keywords as in the Google alerts. Another example is the mobile phone and call processing method of mobile phone described in US 2007/0190986, which discusses presenting data about a caller when he makes a call to the user, which data already exists in the user's mobile device.

Because they do not address some of the needs of mobile users, prior art methods and systems do not fully take into account the constraints of mobile devices such as life of the battery, size of the display, size of memory or additional capabilities such as direct connectivity, anywhere and anytime opportunity and availability. Furthermore, prior art solutions do not address the issue of automatically deciding what information to acquire, when and where to gather it and how to present it to the user in a personalized manner.

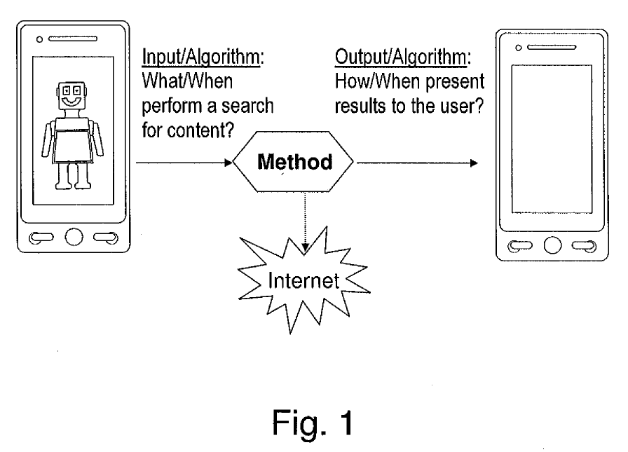

The present invention comprises a system to improve the presentation of data existing on the mobile device, which is adapted to the personal needs of its user. This is schematically shown in FIG. 1. As shown in the figure the Internet is used to dynamically update the data that exists on the mobile device and to present it to the user based on his personal needs.

The system monitors the Internet dynamically for updates on the data existing on the mobile device, to provide information relevant to the personal needs of the user. This process decomposes into five steps described by the following questions:

1. What information to look for?

2. Where to look for it?

3. When to look for it?

4. When to notify the user that new information has become available?

5. How to present the information to the user?

Each step can be controlled deterministically and directly by the user or by the application of a software agent that learns when his user will benefit most from performing this process. The agent also has access to the particular pattern of behavior of the user with his mobile device. Therefore the agent can transform the mobile device into a personal information device that is accessible to its user anytime and anywhere, with the most relevant information for him given his interests, context and presence status. As will be apparent to the skilled person, a very great variety of software agents can be designed, for specific mobile devices, to perform the operations described herein. Providing such software agents is well within the scope of the skilled person and therefore they are not described herein in detail, for the sake of brevity.

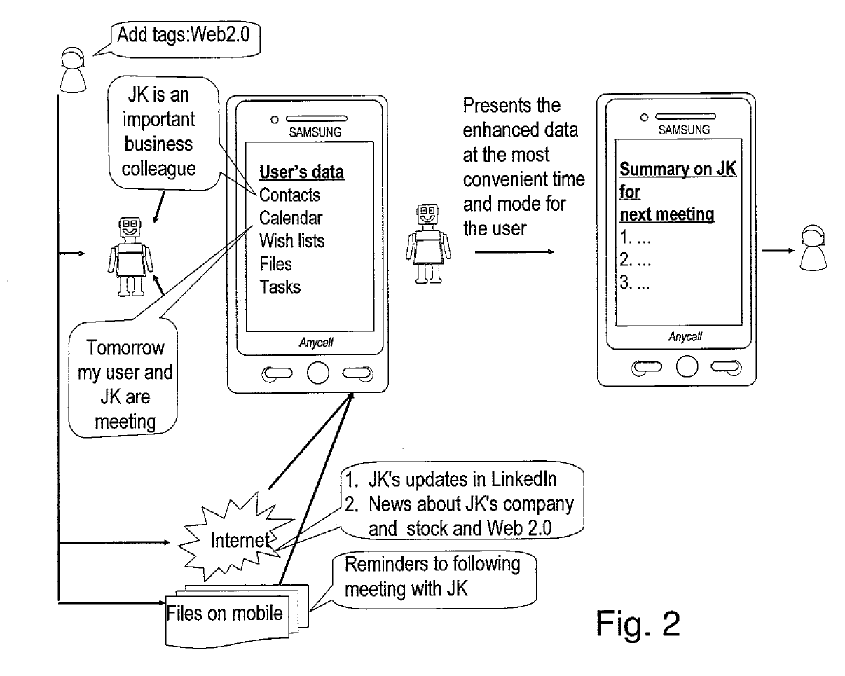

A specific illustrative example of operation according to an embodiment of the invention is shown in FIG. 2, in which the user needs updated information about some contact with whom he is meeting soon. The steps performed in this situation are evident from the figure and from the above description.

The invention, as explained above, is aimed at enhancing the utility of the mobile data that each user keeps on his mobile device. The method includes the process of collecting, managing and presenting personalized information to the user. The invention addresses the particular needs of a mobile user, who is constrained by the interaction with a mobile device limited in battery life, size of screen, and form of interaction (anytime, anywhere). Therefore, a mobile user needs to get information that is personalized and focused on his needs, to maximize the relevancy of the retrieved items given the limitations of the mobile device and its form of interaction.

The invention will further be illustrated by the following step-by-step description. It should be understood that although the user can control each of these steps manually, the following description will focus on the behavior of the autonomous and personal agent.

What content to look for?

The method of the invention enhances the mobile content of the mobile device, particularly but not limited to the following types:

1. Contacts

2. Calendar

3. Wish lists/Tasks lists/Notes/Memos/To do lists.

Enhancing these types of content to make it personal for the mobile user means to present it augmented with updated information collected from the Internet as described in the following uses.

Augmented Caller Id:

Whenever a user receives an incoming call, he can benefit from being shown additional information related to the contact that is calling. If the contact already appears in the user's phone book, the personal agent takes care of maintaining updated information about special contacts (as described in more details below).

The contact may not appear in the phone book but it may appear as a participant of an upcoming meeting. The agent then decides whether this updated information will be presented when the call arrives or the meeting occurs, or some time before, to help the user be prepared for the meeting or call. This is possible since the personal agent maintains also a user profile with information about the pattern of behavior of the user and his mobile device. The agent can predict based on the pattern of communication when a certain call may occur.

The agent can choose what updated information is relevant for the user. For example adding the birthday of the caller to remind the user, or information about mutual events, or reminders that the user has previously entered. In addition updated information that can be retrieved from the Internet, such as news about the company of the caller, status of the stock of his company, etc., can be displayed, along with news related to the contact, such as information from social networks, e.g., LinkedIn, and other relevant sites. In this way, the agent enhances the presentation of information relevant to an incoming call.

Augmented Event—Calendar Item:

The personal agent can enhance the content of a calendar event with information related to the topic of the meeting and its participants. The agent can combine material that the user has stored as a reminder, with updated information retrieved from the Internet, to help the user better prepare for the meeting.

Enhanced Opportunities:

Since the personal agent knows the preferences and patterns of behavior of its user, it can alert him with information found on the Internet that is relevant to wishes that the user may have. These may appear on the mobile device as wish-lists which may be added by the user or can be automatically generated. Whenever an item from the wish list is available on the Internet or some new information has been published, the agent can notify its user.

The agent can also enhance the material that the user keeps on his mobile device, for example if the calendar shows a future vacation in Paris, files with material about hotels or possible attractions in that it may be collected and displayed to the user. The agent can then also provide updated information about Paris before the trip or while traveling. In particular, when the user is already at his vacation destination, he may not have a normal access to the Internet, but he still carries his mobile phone that can update him at the right place and time about possible activities and relevant events (such as a closed restaurant).

Additionally, the agent can monitor information about particular contacts that are relevant to the user based on his interactions through his mobile device. The agent can thus notify the user when some breaking news are published about some relevant contact.

Enhanced Assistance:

Based on the content that appears in the user's tasks list, the agent can search for relevant information that may help the user in fulfilling these tasks while being mobile. For example, buying items in the duty free shop while on his way to some trip. The agent can find information about charging units when electrical power differs at the destination.

Agent Initiated Search:

As explained above, the invention has as an object the presentation of enhanced information at the most convenient time. Since the user is limited by current limitations of the mobile phone (battery life, screen size, memory size, time and cost of performing Web searches), the agent needs to be very focused when choosing what information to enhance, since it does not have spare resources to do that. One option is to have the user choose what content he is interested in updating and enhancing. In addition, the agent can use its knowledge from the learned patterns of the user behavior, to decide which are the contacts that the user will be interested in updating information for (for example, colleagues, the boss, the competitors, frequent contacts, a frequent caller friend). When the content type is a calendar event, then the subject and participants can be used as the keywords for the search. Additional text in the content of the event can also be used (as done usually in syntactic Web searches by trimming off suffixes and common words such as a, the, and etc). Similarly, this can be done for choosing the right content in files, wish-lists and tasks lists.

The software agent can choose what content will serve as most convenient for the user if an update is found for him. In order to perform a search action autonomously to find relevant information to this content we need to know the value function of the specific user for each possible type of content. We also need to have an estimation of the probability of the user needing this content in the given context:

Pr (User needs content|Context)

as shown in Table I below:

TABLE I

| | | Don't search |
|---|---|---|
| | Search content | content |
| User needs content | Value 1 | Value 2 |
| User does not need content | Value 3 | Value 4 |

Where Value 1>Value 4>Value 2>=Value 3

Value 1>0, Value 4 can be zero.

Notice that Value 3 can be larger than Value 2 in case the user misses some relevant piece of information when needed causes costly damage. Value 3 refers to the value that is obtained when a search action is taken while the user did not need the content. Value 2 refers to the case when a search action was not taken and the user did need the content. So although it is stated above that Value 2>=Value 3, there can also be a case where Value2<Value 3, when not having searched for some needed piece of information results in a very bad situation for the user (that is, missing the information needed causes some costly damage). Then, for instance, in the case in which Value 3<Value 2, when, for example, having performed the search action even if not needed was very costly, for example the search process ended the battery needed for some future important call. Value 3 is more costly when using the phone and loosing power for something not needed is more costly than the other activity that could have been performed if the phone was used for some other purpose.

According to a particular embodiment of the invention, for each possible content item that can trigger a search process, a cost-benefit analysis is run first to decide whether the search is worthwhile for that particular item. The analysis is made by comparing the expected utility of searching for information relevant to that item and the expected utility of not searching. The comparison is made, according to this particular embodiment, between the cost of reaching some relevant content and the value of adding the new content found to the knowledge already held by the user. In other words:
a. EU(Search Content|Context)=Pr(User needs content|Context)Value(Search content|User needs content)+(1-Pr(User needs content|Context))Value(Search content|User does not need content).
b. EU(-Search Content|Context)=Pr(User needs content|Context)Value(not Search content|User needs content)+(1-Pr(User needs content|Context))Value(not search content|User does not need content).
c. After equating equations a) and b), we can obtain the value of p* that is the probability of a user needing a content given a context for which the user is indifferent between obtaining a new piece of content or not. If the actual probability (given by a model of Pr (user needs content|context)) is larger or smaller than p* a decision can be made as to whether the automatic action should be to search for a new piece of content given the current context or not.
d. A model of Pr (user needs content|context) is needed. This requires a separate learning algorithm based on statistical methods. Another relevant issue that needs to be handled is the fact that the user may need the content but it does not necessarily mean that there is some item that is relevant and will be found. This will be handled in the Value function (Taking into account what the value is for searching and finding or searching and not finding).
e. If a>b the process moves to the next step in the decision process to check whether the timing is right to perform the search process for that particular piece of content that was chosen to be valuable. This approach assumes that the content and the time are independent variables.

When to look for the relevant content?

Agent-Initiated Timing

Deciding when a search is performed is very important for a mobile user. First of all, the information needs to be available when needed, no matter where the user is as long as he carries his phone. Secondly, the search uses the power of the mobile phone and since the battery life is limited, the time of the search needs to be planned well enough to be efficient. Based on the mobile user pattern of behavior, the agent can choose what is the most convenient time to perform the search, without interfering with the user's usage of the phone.

At a higher level, the agent can choose the convenient time for its user based on the general behavior of the user and its phone by choosing one of the following options:
1. While the phone is recharging
2. Always do it from a server that is always online and the user's phone is idle.
3. When the agent realizes in the user's calendar that the user is busy in a meeting and will be unavailable for calls for a certain interval of time.
4. When the agent realizes based on the communication pattern of his user, that with all likelihood no important calls will be made in the next interval of time.
5. When some important event is about to occur, searching for a predetermined interval of time.

Alternatively, the agent can also consider the content it needs to search and perform a more detailed computation to estimate the worth of the search timing:

Expected utility based computation: We assume for the purposes of the following description that the question whether some content was chosen for a search was already handled in the previous item. Here we only decide if the current time (and context) are convenient (that is beneficial as opposed to costly) for making the search and for how long:
a. Given [t] is some interval starting at time t (and the length maybe given by some value predetermined empirically), and assuming a model of the probability of a user needing the phone for his own use given the context:
b. Compute EU(search content for [t]|context)=Pr(user needs the phone|context) Value(search content for [t]|user needs the phone)+(1-Pr(user needs the phone|context))Value(search content for [t]|user does not need the phone).
c. Compute EU(-search content for [t]|context)=Pr(user needs the phone|context) Value(-search content for [t]|user needs the phone)+(1-Pr(user needs the phone|context))Value(-search content for [t]|user does not need the phone).
d. Needs prior information about the model Pr(user needs phone|context).
e. Compute p* for b) equals c) and decide on the automatic action based on the actual Pr (user needs phone|context) in actual context compared to p.*
f. Keep deciding whether to continue the search for another interval if the new probability for the new context (for the interval after [t] still maintains the relation of e).

Where to look for relevant content?

For the purpose of this invention, the places where updated information is searched is assumed to be set up by default or manually by the user. Alternatively, a cost-benefit analysis can also be performed if the costs of accessing and waiting for information are very different from site to site. The sites that can be set by default include:
1. User's favorites sites;
2. Social networks sites with which the user is associated;
3. Google sites- Google news, etc.;
4. Sites that the user has visited in the past;
5. Sites chosen by the user (for specific business-related information and updates);
6. Other users in a P2P to which the user is subscribed.

When to present the results?

Agent Initiated Decision:

Since the mobile phone is a device with limited power and screen but also an anytime/anywhere carry on, the timing of presenting relevant information is critical. In this step, the agent calculates the most convenient time for the user to see the results found, assuming the presentation may interfere with the user's mobile behavior but can also contribute to the user's need for information.

For example, the agent may have collected important information about some contact. When a call from this contact arrives, the agent may present the updated information in a pop-up window that is shown on the mobile screen while the user is connected to the earphone (or some beep sound may alert the user that such window is presented). In other cases, this information may have been presented before the actual call entered if this was required and considered more urgent. Another example could be that the user gets the results of the updated information before a meeting takes place, or when its mobile GPS senses that the user is at a certain location.

Assuming that the model of the likelihood of a user (indicated hereinafter by “U”) obtaining useful information is available for a given context Pr(U wants to see result|context), compare the following expected utilities:
1. EU(present result obtained to U|context)=Pr(U wants to see result|context)Value(present result to U|U wants to see result)+(1-Pr(U wants to see result|context))Value(present result to U|U does not want to see result).
2. EU(-present result obtained|context)=Pr(U wants to see result|context)Value(do not present result|U wants to see result)+(1-Pr(U wants to see result|context))Value(do not present result|U does not want to see result).
3. This computation takes into account the negative value of disturbing the user if he does not want to get results presented.
4. The context includes a set of configuration parameters that may describe the current state of the user and his mobile device. In particular this context includes the current time t.
   a. After equating equations 1) and 2), we can obtain the value of p* that is the probability of a user wanting to see a result given his context for which the user is indifferent between being presented or not some new information. If the actual probability (given by a model of Pr (U wants to see result|context)) is larger or smaller than p* a decision can be made as to whether the automatic action should be to present a result given the current context or not.
   b. A model of Pr(U wants to see result|context) is needed. This requires a separate learning algorithm based on statistical methods.

How to present the information to the user?

Agent Initiated Decision:

A mobile user needs the minimal amount of information that is relevant to his tasks and which has the maximal value. This results from the limitations of a mobile device in terms of the size of the screen and the options the user may have to manipulate large amounts of information. On the other hand the mobile device is an anytime/anywhere carry on, so the presentation of relevant and personalized information needs to be focused on the personal needs and arrive on time for the dynamic use of the phone.

For the purpose of this invention we assume that the user can see the results in a pop-up window or by getting them in an SMS. Therefore, performing the action will be equivalent to “Present Pop-Up” and not performing the action will be equivalent to “Send by SMS” Then, we can apply the same basic cost-benefits analysis algorithm by computing:
1. EU(Pop-up|context)=Pr(user wants pop-up|context)Value(pop-up|User wants pop-up)+(1-Pr(User wants pop-up|context))Value(pop-up|User wants SMS).
2. EU(-Pop-up|context)=Pr(user wants pop-up|context)Value(-pop-up|User wants pop-up)+(1-Pr(User wants pop-up|context))Value(-pop-up|User wants SMS).

Then we find the value p* such that both equations get equal and compare the actual value of Pr(user wants pop-up|context) to p* and then choose pop-up or SMS accordingly.

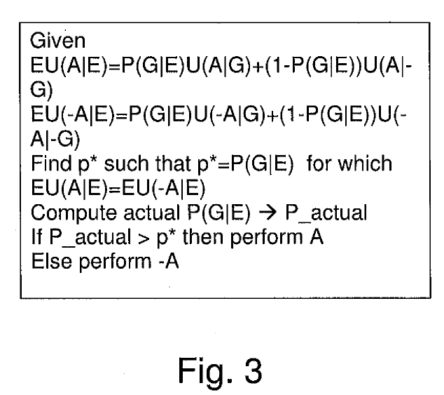

The basic algorithm that the personal agent runs to calculate the worth of performing a specific action is given in FIG. 3. Each step in the data enhancement process will assign the corresponding action A, goal G and evidence E based on the Table II below.

TABLE II

| | Action A | Goal G | Evidence E |
|---|---|---|---|
| What content to | Search | User needs content | Context |
| search? | | | |
| When to search? | Search for [t] | User needs phone | Context |
| When to present the | Present result | User wants to see | Context |
| results? | | result | |
| How to present the | Present in | User wants to get a | Context |
| results | pop- | popup | |
| | up/Present by | | |
| | SMS | | |

As will be apparent to the skilled person the above description of preferred embodiments has been provided for the purpose of illustration only and is not intended to limit the invention in any way. The solution provided by the invention allows enhancing the content the user already has on his mobile device by finding relevant and updated information on the Internet. The invention permits to deliver the minimal amount of relevant content with the maximal value, taking into account the limitations of the mobile device in terms of battery life, size of screen, memory size and the patterns of behavior of the particular user. The invention answers to each one of the needs of the mobile user: what information to acquire, when to acquire, how to inform the user and at what times and finds the answers with the highest impact on the particular user.

1. A method for the personalized enhancement of a mobile device data comprising acquiring from the World Wide Web, through a mobile device, information relevant to said mobile device's data and displaying said updated information at the time and in a manner compatible with the user's pattern of use of the mobile device and to the user's relevant personal preference.

2. A method according to claim 1, wherein the information is selected from information relevant to the user's contacts, calendar items, files, sms messages, and WishLists.

3. A method according to claim 1, wherein data is acquired during periods of time when said acquisition does not interfere with the user's usage of the mobile device.

4. A method according to claim 1, wherein the type of information and/or the times of update are selected based on probabilities of need and/or usage by the user, based on the user's previous patterns of use.

5. A method according to claim 1, wherein the mobile device is a cellular phone.

6. A method according to claim 1, wherein each step is controlled deterministically and directly by the user.

7. A method according to claim 1, wherein each step is controlled by the application of a software agent.

8. A method according to claim 1, wherein the quality and/or the length of the content presented to the user is predetermined by the user or factory preset.

9. A method according to claim 1, wherein the quality and/or the length of the content presented to the user is determined according to variables of the mobile device.

10. A method according to claim 9, wherein the variables of the mobile device are selected from remaining battery life and scheduled user activities.
